(19) United States
(12) Patent Application Publication
(10) Pub. No.: US 2007/0171043 A1
(43) Pub. Date: Jul. 26, 2007

(54) Method of controlling monitoring control apparatus, computer program product, monitoring control apparatus, and electronic apparatus

(75) Inventor: Takashi Ichinose, Yamanashi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/656,448

(22) Filed: Jan. 23, 2007

(30) Foreign Application Priority Data
Jan. 25, 2006 (JP) 16314/2006

(51) Int. Cl. G08B 19/00

(52) U.S. Cl. 340/521

(57) ABSTRACT

A method of controlling a monitoring control apparatus includes receiving a plurality of alarm signals, selecting at least one of the plurality of alarm signals, and sending the at least one alarm signal to a processor.

### BACKGROUND OF THE INVENTION

1. Field of the Invention

The present invention relates to a method of controlling a monitoring control apparatus, a computer program product, a monitoring control apparatus, and an electronic apparatus, more particularly to a method of controlling a monitoring control apparatus for collecting alarm information from a monitoring object (e.g., a monitoring object part in an apparatus) in a computer system or the like to report the information to its host processor, as well as a computer program product, a monitoring control apparatus, and an electronic apparatus.

2. Description of the Related Art

For example, JP-A No. 32245/1991 discloses two alarm signal control units 70 and 80 for collecting alarm information generated in a plurality of devices (slaves) with use of a monitoring device (master) in a computer system. A configuration according to the first method, as shown in FIG. 1, includes host processor 71, alarm information collecting device 72, and a plurality of alarm detecting units 73 to 75. Each of alarm detecting units 73 to 75 is connected to alarm information collecting device 72 through alarm signal line 76. Each of alarm detecting units 73 to 75 to be monitored, when detecting an alarm event, sends the alarm to alarm information collecting device 72 through alarm signal line 76, which is a dedicated line. After that, alarm information collecting device 72, which is a monitoring device, transfers the alarm information to host processor 71.

A configuration according to the second method, as shown in FIG. 2, includes a plurality of alarm detecting units 83 to 85 and common bus interface device 82 that are connected to each another through common buses 86 and 87. When requested from host processor 81, common bus interface device 82 collects alarm information from alarm detecting device of given monitoring device through a common bus 86 and 87. Alarm information accumulated in common bus interface device 82 is sent to host processor 81.

Apart from the above methods, there is another alarm collecting method for collecting an alarm occurred state of a single or a plurality of functional blocks connected to a CPU through a bus respectively. The method is disclosed in JP-A No. 157538/1992. According to the method, the CPU confirms that the “empty” signal is not active. The “empty” signal indicates an empty state of an FIFO that holds an alarm occurred state. Then, the CPU keeps reading the content of the FIFO through an input port until the “empty” signal becomes active. Thus the CPU comes to know the details of how the alarm occurred and that the alarm is already reset.

Furthermore, JP-A No. 96277/1996 discloses a processing system for monitoring troubles of each individual terminal of a communication system at the center side. When a trouble occurs at a terminal, the CPU checks a warning reduced terminal table to check the contents of the warning table only about the trouble occurred terminal.

Furthermore, JP-A No. 24635/2001 discloses a system includes a monitoring terminal and a plurality of terminals to be monitored connected to a network respectively. Each of the terminals to be monitored records an object ID of a status changed item and its status.

### SUMMARY OF THE INVENTION

However, each of the above conventional techniques may have suffered a problem that the processor load increases. This problem may be caused by that a terminal that sends an alarm signal to the processor does not select at least one of a plurality of alarm signals when sending it to the processor.

According to the technique disclosed in JP-A No. 32245/1991, neither alarm information collecting device 72 nor common bus interface device 82 sends an alarm signal selected from among a plurality of alarm signals to host processor 71 or 81. According to the technique disclosed in JP-A No. 157538/1992, the CPU must collect alarm status values from all of FIFOs. According to the technique disclosed in JP-A No. 96277/1996, the CPU must search a unit in which a trouble has occurred. And according to the technique disclosed in JP-A No. 24635/2001, no selection is made for some of status changed items in a plurality of object terminals to be monitored when sending those alarm signals to the monitoring terminal.

The exemplary feature of the present invention may be to reduce the load of the processor for processing alarm information.

The present invention provides a method of controlling a monitoring control apparatus, including receiving a plurality of alarm signals, selecting at least one of the plurality of alarm signals, and sending the at least one alarm signal to a processor.

The present invention provides a computer program product including a program for causing a monitoring control apparatus to perform the method of controlling a monitoring control apparatus described above.

The present invention provides a monitoring control apparatus, including an alarm information collector that receives a plurality of alarm signals, and an alarm bus controller that selects at least one of the plurality of alarm signals, the alarm bus controller sending the at least one alarm signal to a processor.

The present invention provides an electronic apparatus, including the alarm signal controller described above, an alarm detector that monitors a part in the electronic apparatus and sends the alarm signal to the alarm signal controller, and a processor that receives an alarm signal from the alarm signal controller.

The exemplary advantage of the present invention may reduce the load of the processor for processing alarm information. This may be because a sender of an alarm signal to the processor receives a plurality of alarm signals, selects at least one of the plurality of alarm signals, and sends the at least one alarm signal to a processor.

### BRIEF DESCRIPTION OF THE DRAWINGS

Exemplary features and advantages of the present invention will become apparent from the following detailed description when taken with the accompanying drawings in which:

FIG. 1 is a diagram showing a configuration of conventional alarm signal control apparatus 70;

FIG. 2 is a diagram showing a configuration of conventional alarm signal control apparatus 80;

FIG. 3 is an exemplary block diagram showing a configuration of alarm signal control apparatus of the present invention;

FIG. 4A is an exemplary flow chart showing the operation of exemplary monitoring control part 2 of the present invention;

FIG. 4B is an exemplary flow chart of details of step A1 shown in FIG. 4A;

FIG. 4C is an exemplary flow chart of details of step A3 shown in FIG. 4A;

FIG. 5 is an exemplary diagram showing a configuration of exemplary alarm information collecting part 23;

FIG. 6 is an exemplary flow chart showing the operation of exemplary alarm information collecting part 23;

FIG. 7 is an exemplary diagram showing a configuration of exemplary FIFO means 22 of exemplary monitoring control part shown in FIG. 3;

FIG. 8A is an exemplary flow chart showing the input operation of exemplary FIFO means 22;

FIG. 8B is an exemplary flow chart showing the output operation of exemplary FIFO means 22;

FIG. 9 is a diagram showing an exemplary state machine of an exemplary alarm bus control part;

FIG. 10 is an exemplary timing chart of an exemplary alarm bus control part;

FIG. 11 is an exemplary block diagram showing a configuration of exemplary alarm signal control unit 100 in a second exemplary embodiment of the present invention; and

FIG. 12 is an exemplary block diagram showing a configuration of exemplary alarm signal control unit 100 in a third exemplary embodiment of the present invention.

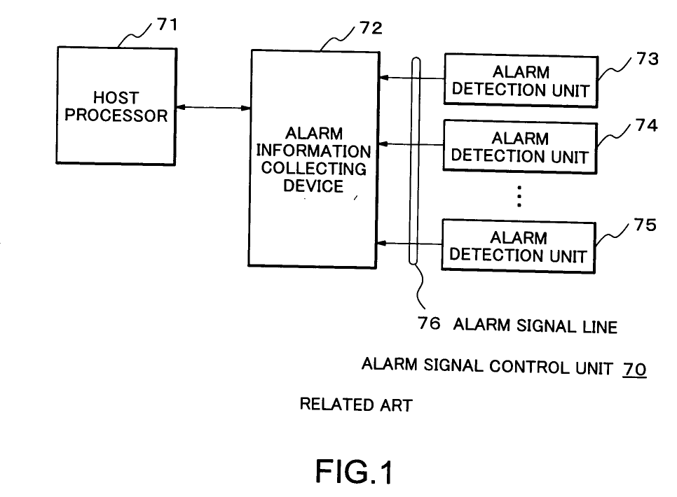

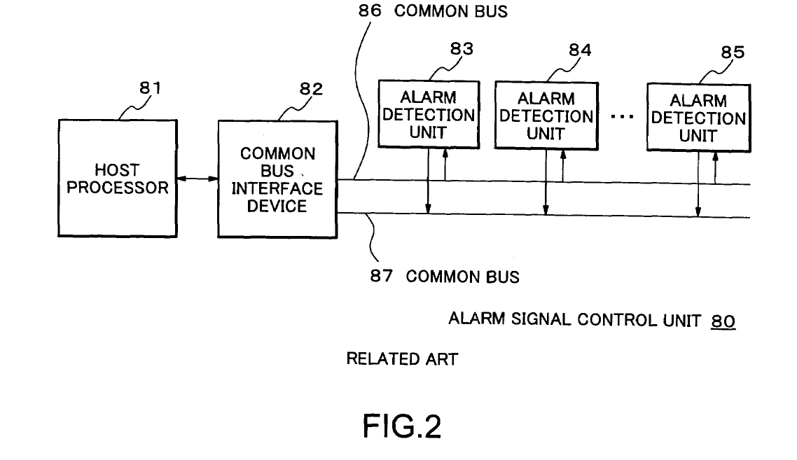

### DESCRIPTION OF THE EXEMPLARY EMBODIMENTS

Hereunder, the exemplary embodiment of the present invention will be described in detail with reference to the accompanying drawings.

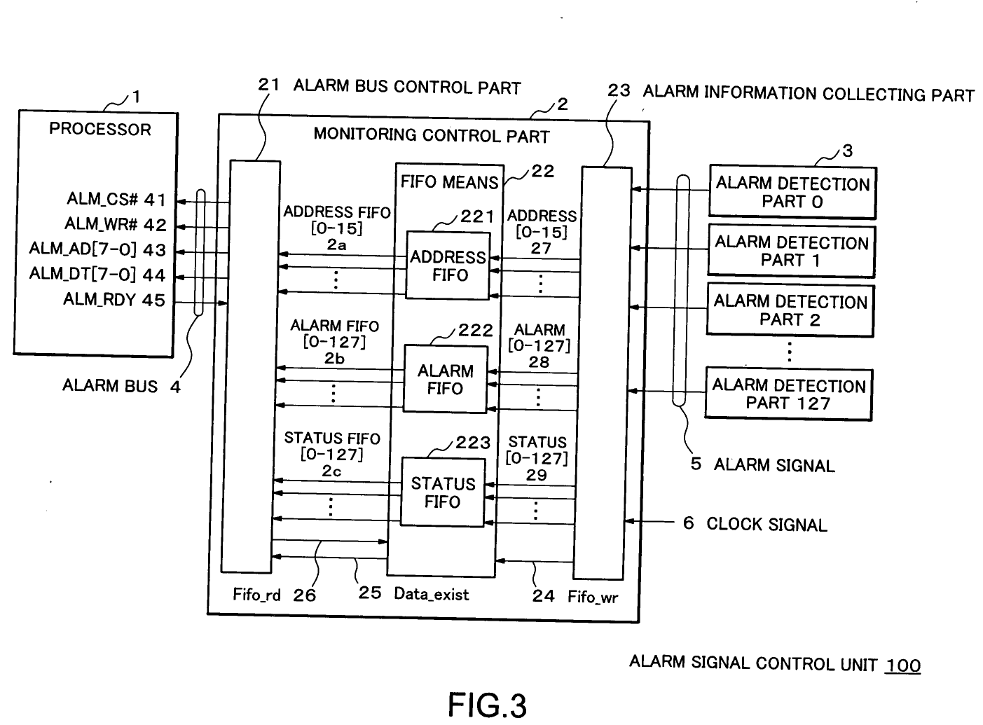

FIG. 3 is an exemplary block diagram showing a configuration of alarm signal control unit 100 in a first embodiment of the present invention. Alarm signal control unit 100 in this first embodiment may include processor 1, monitoring control part 2, and a plurality of alarm detecting parts [0 to 127] 3. This alarm signal control unit 100 may collect alarm information from alarm detecting part 3 provided in each of many object parts to be monitored, for example, in a computer system and reports the alarm information to host processor 1.

In this first embodiment, for example, 128 alarm detecting parts [0 to 127] maybe provided. This is only an example, however. The number of alarm detecting parts may be more or less. Each of alarm detecting parts 3 may be connected to monitoring control part 2 through alarm signal line 5. Alarm detecting part 3, when detecting an alarm with its alarm detecting function (not shown) assigned to itself individually, may change the status of an alarm output signal from “0” to “1”.

For example, monitoring control part 2 may include alarm bus control part 21, FIFO means 22, and alarm information collecting part 23. Alarm information collecting part 23 may obtain alarm signal 5 from each alarm detecting part at a timing of clock signal 6. Alarm information collecting part 23 may receive a plurality of alarm signals, FIFO means 22 may accumulate a plurality of alarm signals in parallel on the basis a FIFO (First-In First-Out) method, and alarm bus control part 21 may send some or all of a plurality of alarm signals to the processor selectively.

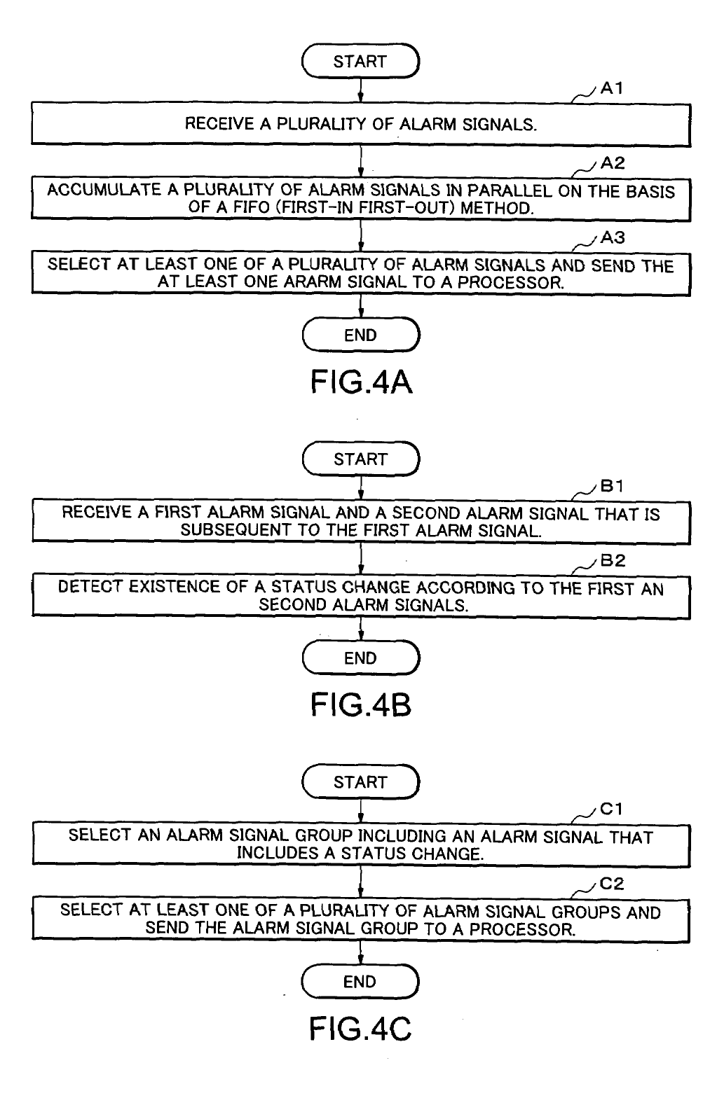

Next, a description will be made briefly for the operation of monitoring control part 2 of the present invention. FIG. 4A is an exemplary flow chart showing the operation of exemplary monitoring control part 2 of the present invention. At first, monitoring control part 2 receives a plurality of alarm signals (A1) and accumulates those signals in parallel on the basis of the FIFO (First-In First-Out) method (A2), then selects at least one of those alarm, signals and sends the at least one alarm signal to the processor (A3).

Next, a description will be made for a detailed example of A1 shown in FIG. 4A. FIG. 4B is an exemplary flow chart showing the details of step A1 shown in FIG. 4A. At first, monitoring control part 2 receives a first alarm signal and a second alarm signal that is subsequent to the first alarm signal (B1). Monitoring control part 2 then detects existence of a status change according to the first and second alarm signals (B2).

Next, a description will be made for a detailed example of step A3 shown in FIG. 4A. FIG. 4C is an exemplary flow chart showing the details of step A3 shown in FIG. 4A. Monitoring control part 2 selects an alarm signal group that includes the status change detected from first alarm signal among the plurality of alarms (C1). Monitoring control part 2 selects at least one of a plurality of alarm signal groups and sends the alarm signal groups to the processor (C2).

Next, monitoring control part 2 will be described further in detail.

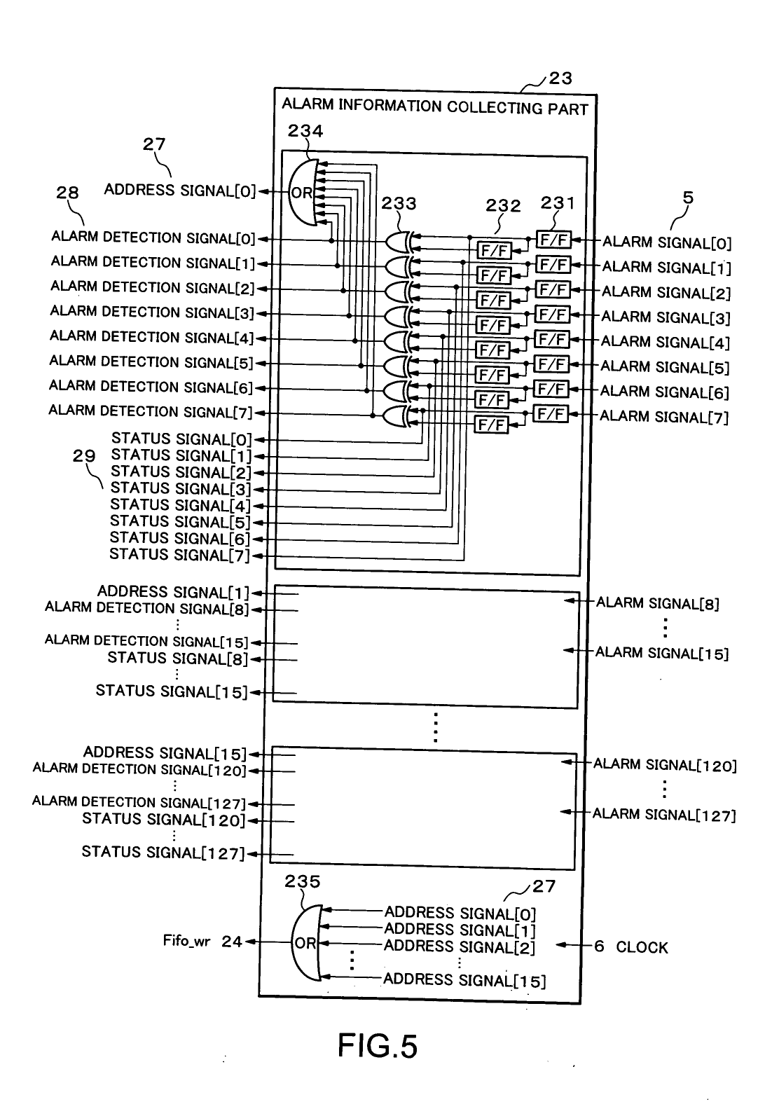

FIG. 5 is an exemplary diagram showing a configuration of exemplary alarm information collecting part 23 of exemplary monitoring control part 2 shown in FIG. 3.

For example, as shown in FIG. 5, alarm information collecting part 23 may input a plurality of alarm signals [0 to 127] 5 from a plurality of alarm detecting parts 3 (e.g., 128 alarm detecting parts 3) disposed in places of an object electronic device, as well as clock signal 6. In alarm information collecting part 23, 128 alarm signals 5 may be divided into some groups, each including a plurality of alarm signal lines 5 (e.g., 8 signal lines) and handled as 16 signal groups. In other words, each of a plurality of alarm signals may belong to one of alarm signal groups. In FIG. 5, only a configuration of a signal group of alarm signals [0 to 7] is shown in detail. However alarm signals [16 to 23], . . . , alarm signals [120 to 127] are configured in the same way, respectively.

Next, a description will be made for a configuration of alarm information collecting part 23 mainly focusing on a configuration of alarm signals [0 to 7]. Alarm signals [0 to 7] may be collected into one group. For example, alarm information collecting part 23 may include F/F (flip-flop) 231, F/F 232, XOR circuit 233, OR circuit 234, and OR circuit 235. Alarm information collecting part 23 operates on the basis of clock 6.

F/F 231 may be provided for each of alarm of signals [0 to 7] 5. F/F 231 inputs alarm signals [0 to 7] 5. F/F 231 outputs alarm signals [0 to 7] 5 to F/F 232, XOR circuit 233, and FIFO means 22 at the next clock timing respectively. Alarm signals [0 to 7] 5 output to FIFO means 22 as status signals [0 to 7] 29 respectively.

F/F 232 may be provided for each of alarm signals [0 to 7] 5. F/F 232 inputs alarm signals [0 to 7] 5 from F/F 231. F/F 232 outputs alarm signals [0 to 7] 5 to XOR circuit 233 at the next clock timing.

XOR circuit 233 may be provided for each of alarm signals [0 to 7] 5. XOR circuit 233 inputs alarm signals [0 to 7] 5 from F/F 231 and F/F 232. XOR circuit 233 outputs alarm detecting signals [0 to 7] 28 to OR circuit 234 and FIFO means 22. XOR circuit 233 inputs a current alarm signal (first alarm signal) inputted from F/F 231 and a last alarm signal (second alarm signal) inputted from F/F 232. If those two inputs are identical, XOR circuit 233 outputs “0” as alarm detection signal [0 to 7] 28. If those two inputs are different, XOR circuit 233 outputs “1” as alarm detection signal [0 to 7] 28.

OR circuit 234 may be provided for each signal group. With respect to a signal group of alarm signals [0 to 7] 5, OR circuit 234 inputs 7 alarm detection signals [0 to 7] 5 from 7 XOR circuits 233. If “1” is included in any one of alarm detection signals [0 to 7] 5, OR circuit 234 outputs “1” as address signal [0] 27.

OR circuit 235 may be provided just one for alarm information collecting part 23. OR circuit 235 inputs 16 address signals [0 to 15] 27 from XOR circuit 234 of each signal group. If “1” is included in any one of address signals [0 to 15], OR circuit 235 outputs Fifo_wr signal 24 to FIFO means 22.

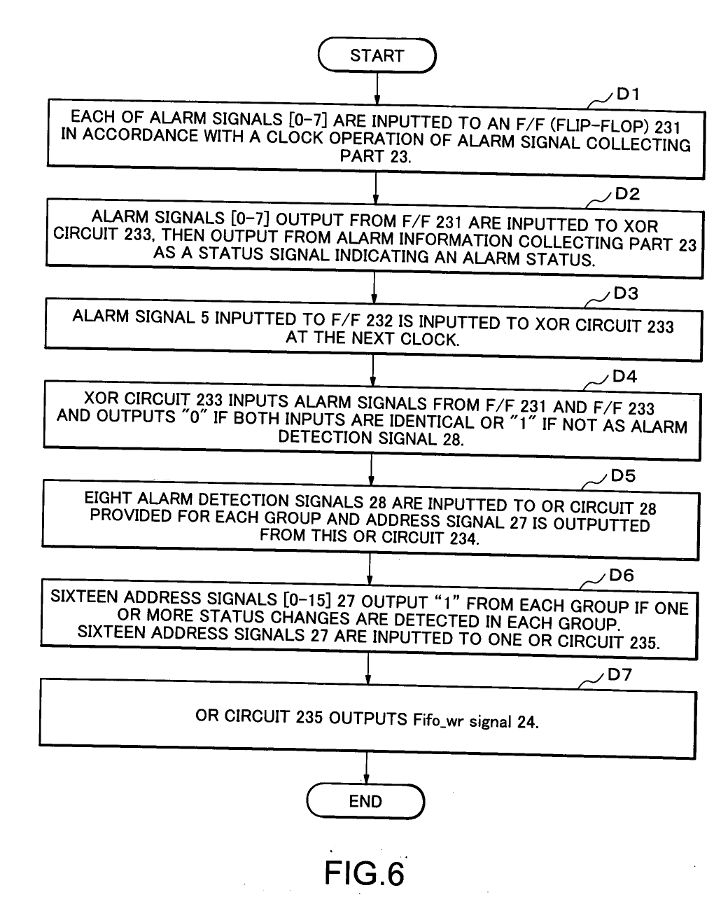

Next, the operation of alarm information collecting part 23 will be described. FIG. 6 is an exemplary flow chart showing the operation of exemplary alarm information collecting part 23. As shown in FIGS. 5 and 6, each of 8 alarm signals [0 to 7] is inputted to F/F 231 on the basis of the clock of alarm information collecting part 23 (D1), then output from F/F 231 at the next clock and inputted to F/F 232 and XOR circuit 233.

The first alarm signal is then output from alarm information collecting part 23 as status signal 29 indicating the alarm status (D2). Alarm signal 5 inputted to subsequent F/F 232 is inputted to XOR circuit at the next clock (D3) and the signal is then output as alarm detection signal 28.

XOR circuit 233 inputs a first alarm signal from F/F 231 and a second alarm signal from F/F 232. If the two inputs are identical, XOR 233 outputs “0”. If those two inputs are different, XOR 233 outputs “1” as alarm detection signal 28 (D4). In other words, XOR circuit 233 inputs a first alarm signal from F/F 231 and a second alarm signal that is subsequent to the first alarm signal from F/F 232 to detect whether or not a status change has occurred.

8 alarm detection signals 28 are inputted to OR circuit 234 provided for each group and this OR circuit 234 outputs address signal 27 (D5). In other words, OR circuit 234 detects the alarm 25 signal group (8 alarm detection signals 28) including the first alarm signal indicating a status change detected by XOR 233.

Each group includes 16 address signals 27 indicates “1” if one or more status changes are detected in the group. Also, 16 address signals 27 are inputted to one OR circuit 235 (D6) and this OR circuit 235 outputs Fifo_wr signal 24 (D7).

In the configuration as described above, alarm information collecting part 23 inputs 128 alarm signals and outputs 16 address signals [0 to 15] 27, 128 alarm detection signals [0 to 127] 28, and 128 status signals [0 to 127]. Alarm information collecting part 23 uses F/Fs 231 and 232 that operate with clock 6 respectively to compare the current status of each alarm signal 5 with its last status (one cycle before).

If a status change is detected in any of those 128 signals, “1” is set in the corresponding bit of alarm detection signal 28 and the changed signal status “1” or “0” is set in the corresponding bit of 128 status signals 29. Furthermore, alarm detection signals 28 are handled in units of 8 bits. If “1” is set to indicate a status change in any one of the 8 bits, “1” is set in the corresponding bit of 16 address signals 27.

Furthermore, if an alarm to be written in FIFO means 22 shown in FIG. 3 occurs, that is, if “1” is set in any one of address signals 27, alarm information collecting part 23 outputs Fifo_wr signal 24 to FIFO means 22 through OR circuit 235.

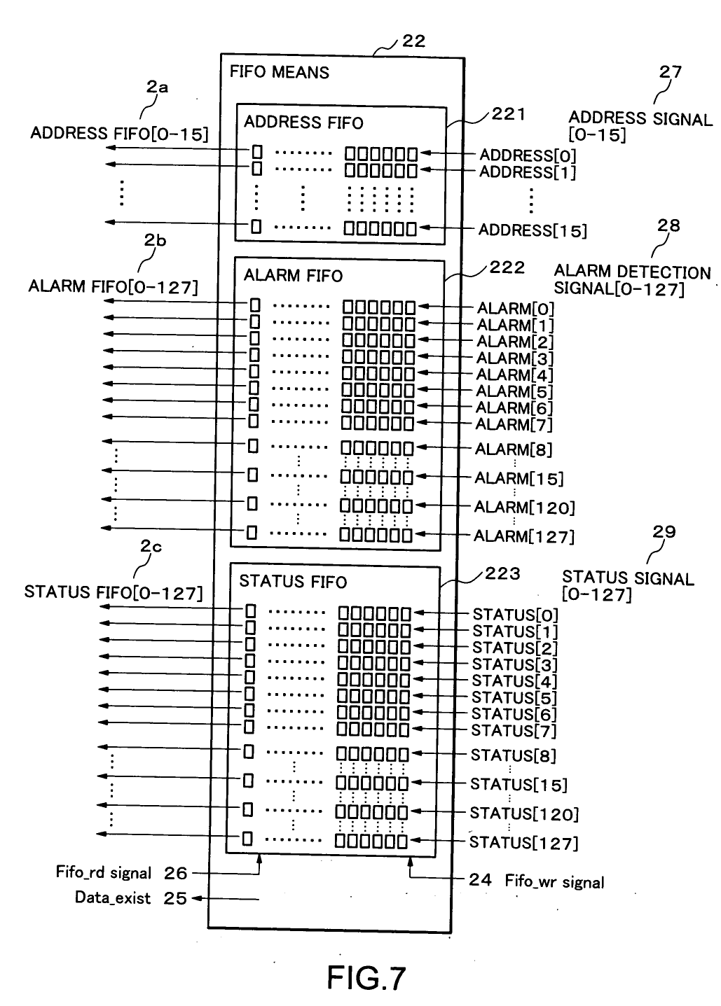

FIG. 7 is an exemplary diagram showing a configuration of the exemplary FIFO means of the exemplary monitoring control part shown in FIG. 3. As shown in FIGS. 3 and 7, FIFO means 22 may include, for example, address FIFO 221 for storing address signals 27, alarm FIFO 222 for storing alarm detection signals 28, and status FIFO 223 for storing status signals 29. Each FIFO (First-In First-Out) structured so that inputs are output in an input sequence. The FIFO can hold a plurality of data temporarily by assuring their input sequential order.

In FIG. 7, if FIFO means 22 is assumed to be a matrix, a number of rows is defined as a bit width and a number of columns is defined as a number of steps. For example, in FIFO means 22, a bit width (number of rows in a column) includes a plurality of bits (e.g., 272 bits) corresponding to address signals [0 to 15] 27, alarm detection signals [0 to 127] 28, and status signals [0 to 127]. FIFO means 22 includes a plurality of steps, each step including the bit widths.

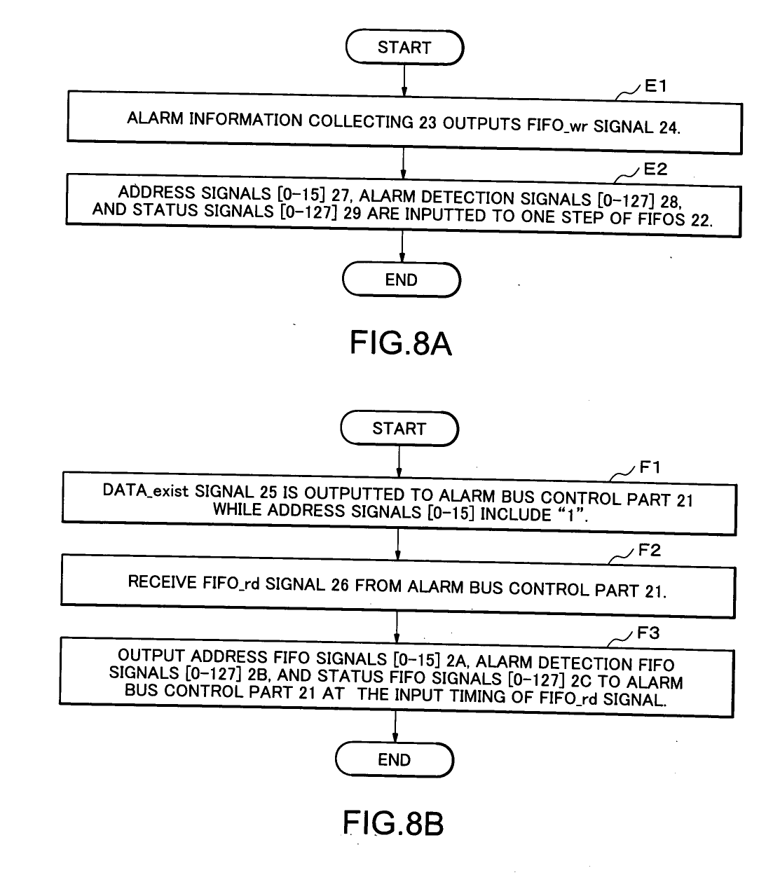

Next, the operation of FIFO means 22 will be described. FIG. 8A is an exemplary flow chart showing input operations of exemplary FIFO means 22. FIG. 8B is an exemplary flow chart showing output operations of FIFO means 22.

FIFO means 22, when Fifo_wr signal 24 is output from alarm information collecting part 23, inputs address signals [0 to 15] 27, alarm detection signals [0 to 127] 28, and status signals [0 to 127] 29 in one step of FIFO 22 at the output timing (E2) Consequently, the synchronism of the alarm information in the same step in each FIFO is assured.

Furthermore, FIFO 22, while holding effective data in itself (address signals [0 to 15] include “1”), outputs Data_Exist signal 25 to alarm bus control part 21 (F1). Receiving Fifo_rd signal 26 from alarm bus control part 21 in response to signal 25, FIFO means 22 outputs the first step data, that is, address FIFO signals [0 to 15] 2a, alarm detection FIFO signals [0 to 127] 2b, and status FIFO signals [0 to 127] 2c to alarm bus control part 21 at the input timing of Fifo_rd signal (F3).

Next, alarm bus control part 21 will be described. In this exemplary embodiment, alarm bus control part 21 outputs ALM_CS# signal 41 indicating holding of information to be notified to processor 1, ALM_WR# signal 42 indicating a write operation for processor 1, ALM_AD [7 to 0] signal 43 that is an 8-bit address for notifying address FIFO signal 2a to processor 1, and ALM_DT [7 to 0] signals 44 for notifying alarm signal FIFO signal 2b and status FIFO signal 2c to processor land inputs ALM_RDY signal 45 indicating that processor 1 has logged ALM_AD [7 to 0] signals 43 and ALM_DT [7 to 0] signals 44.

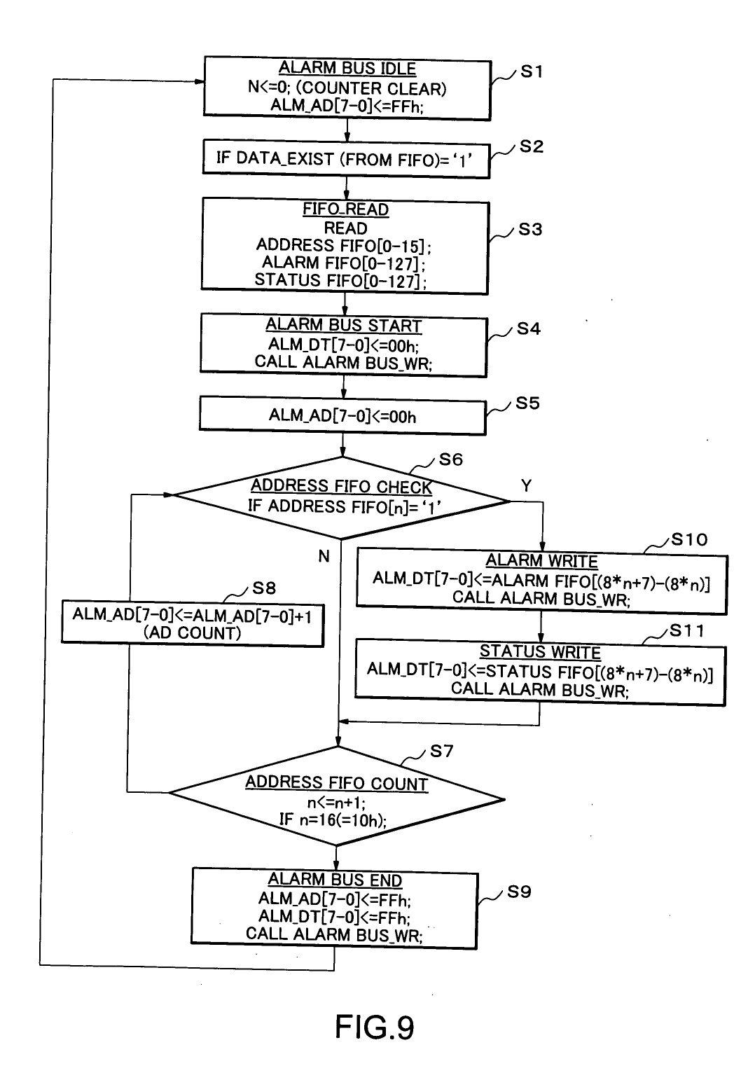

FIG. 9 is a diagram showing an exemplary state machine of exemplary alarm bus control part 21. This state machine default “alarm bus_idle” (S1) indicates a status of waiting for a status change of Data_exist signal 25 received from FIFO means 22 to “1”. At this time, the initial value of a counter is cleared to 0 and a default value “FFh” is set in ALM_AD [7 to 0] signals 43. If the status of Data_exist signal 25 is changed to “1” indicating holding of effective data (S2), alarm bus control part 21 goes to “FIFO_rd” state (S3). In this “FIFO_rd” state, alarm bus control part 21 outputs FIFO_rd signal 26 to FIFO means 22 and reads values of address FIFO signals [0 to 15] 2a, alarm detection FIFO signals [0 to 127] 2b, and status FIFO signals [0 to 127] 2c that are responses to FIFO_rd signal 26. Then, alarm bus control part 21 goes to the next state “ALM_bus start” (S4).

In the “ALM bus start” (S4), alarm bus control part 21 sets “00h” in ALM_DT [7 to 0] signals 44 and combined with already set ALM_AD [7 to 0] signals 43=“FFh” to execute writing to processor 1. In this exemplary embodiment, a combination of this ALM_AD [7 to 0] signals 43=“FFh” and ALM_DT [7 to 0] signals 44=“00h” means start of transferring alarms logged at the same clock timing to alarm bus 4. Receiving the combination of signals, processor 1 that is ready for transfer returns ALM_RDY signal 45. Receiving ALM_RDY signal 45, alarm bus control part 21 sets “00h” in ALM_AD [7 to 0] signals 43 (S5) and goes to the next state “address signal_check” (S6).

Instate S6 “address signal_check” (S6), alarm bus control part 21 confirms whether or not “1” is set in a bit of address FIFO [0 to 15] signals 2a indicated by counter “n” (initial value=0), that is, a region indicated by address FIFO [n] includes effective data. Address FIFO [n]=0 indicates that no abnormality is detected in 8 alarm signals corresponding to the address signal. Thus, alarm bus control part 21 goes to state S7 “address signal_count”.

In this state (S7), alarm bus control part 21 increases the “n” value by one. If “n” is 16 or under, alarm bus control part 21 increases the value of ALM_AD [7 to 0] signals 43 by one (S8) and returns to state S6 “address signal_check”. Furthermore, in state S7, if “n” is 16, it indicates that all the 16 bits of address FIFO signals [0 to 15] are already checked. Thus, alarm bus control part 21 goes to state S9 “alarm bus_end” to exit the processing.

On the other hand, if FIFO [n]=1 is set in state S6 “address FIFO_check”, it means that a status change has occurred in one or more 8-bit alarm signals corresponding to the address FIFO [n]. Alarm bus control part 21 thus goes to state S10 “alarm write”. In this state, alarm bus control part 21 sets the value of a region indicated by alarm FIFO [8(8×n+7)−(8×n)] in ALM_DT [7 to 0] signals 44 and writes data in processor 1.

Consequently, an 8-bit alarm FIFO signal corresponding to address FIFO [n] is written in processor 1. Processor 1 executes a predetermined processing in response to this write operation. When alarm bus control part 21 gets ready for the next operation, processor 1 sends ALM_RDY signal 45 to alarm bus control part 21. After that, alarm bus control part 21 goes to state S11 “status_write” and sets the value of a region indicated by status FIFO [(8×n+7)−(8×n)] in ALM_DT [7 to 0] signals 44, then writes data in processor 1. Receiving ALM_RDY signal 45 from processor again, alarm bus control part 21 goes to state S7 “address FIFO_count” to execute the processing corresponding to the next address FIFO signal.

Ending a check and a processing indicated by every 16-bit address FIFO signal, alarm bus control part 21 sets ALM_AD [7 to 0] signals 43=“FFh” and ALM_DT [7 to 0] signals 44=“FFh” indicating the end of transfer of simultaneously occurred alarms, then writes data in processor 1. When ALM_RDY signal 45 is returned from processor 1, alarm bus control part 21 returns to the first state 1 “alarm bus_idle”.

Such way, monitoring control part 2 divides 128 alarm signals into 16 alarm signal groups and creates an address signal indicating a status change of each of the signal groups and stores the signals on the basis of the FIFO method. Monitoring control part 2 sends an alarm signal and a status signal of only a signal group in which a status change is detected to processor 1. In other words, each of a plurality of alarm signals belongs to one of a plurality of alarm signal groups,.each including an alarm signal.

Thus, an address signal indicating an existence of a status change is created for an entire signal group and stored on the basis of the FIFO method. The alarm bus control part may send only some alarm signal groups in which a status change occurred alarm signal is detected respectively to the processor.

If an alarm signal is inputted to an FIFO, the alarm occurred time series is assured and the processor load may be averaged to transfer an alarm signal when the processor gets ready.

Furthermore, the processor load may also be reduced by monitoring each of a plurality of alarm signal groups and by sending the alarm information of only the alarm occurred group to the processor. In this exemplary embodiment, information of the whole group that includes a status change detected alarm signal is sent to the processor. However, it is also possible to send only the information of a status change detected alarm signal to the processor instead of sending the information of the whole group.

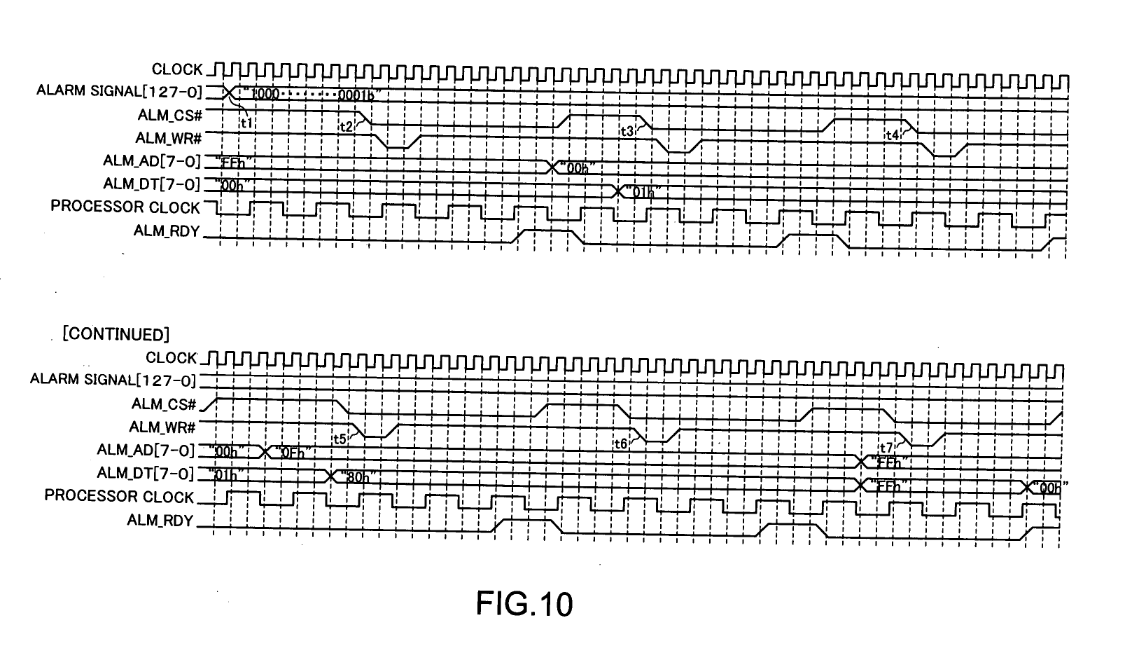

FIG. 10 is an exemplary timing chart of an exemplary alarm bus control part. The timing chart shown in FIG. 10 is for alarm signals [0] and [127] that are detected simultaneously. Assume now that an alarm signal [0] (ALM_AD=00h/ALM_AD=bit 0) and an alarm signal [127] (ALM_AD=0Fh/ALM_DT=bit 7) have been detected at time t1 simultaneously in two alarm detection parts of those [0 to 127] disposed in places of an object device. Alarm bus control part 21 then inputs those alarm signals through FIFO means 22 and issues Write transaction of ALM_AD=FFh/ALM_DT=00h (t2). As described above, in this embodiment, such a combination means start of alarm bus transfer.

Waiting for ALM_RDY signal 45 from the processor, alarm bus control part 21 reports the first detected alarm signal [0] to the processor. In other words, alarm bus control part 21 sets ALM_AD=00h/ALM_DT=01h and issues a Write transaction (t3). After that, receiving ALM_RDY, alarm bus control part 21 issues a Write transaction of ALM_AD=00h/ALM_DT=01h again (t4). This means that a combination with the transaction at t3 has made the alarm signal status High.

Next, alarm bus control part 21 goes to a processing of alarm signal [127] and issues a Write transaction of ALM_AD=0Fh/ALM_DT=80h (t5). This means that an alarm exists in the alarm signal [127]. Then, alarm bus control part 21 issues a Write transaction of ALM_AD=0Fh/ALM_DT=80h (t6). This means that the transactions at t5 and at t6 are combined, thereby the status of the alarm signal [127] has become High.

Finally, alarm bus control part 21 issues a Write transaction of ALM_AD=FFh/ALM_DT=FFh (t7). The combination of the transactions indicates end of alarm bus transfer for simultaneously occurred alarms. Hereinafter, alarm bus control part 21 goes into idle status. The combination of start and end of alarm bus transfer is not limited only in this; any addresses may be combined unless otherwise they are not used as real data.

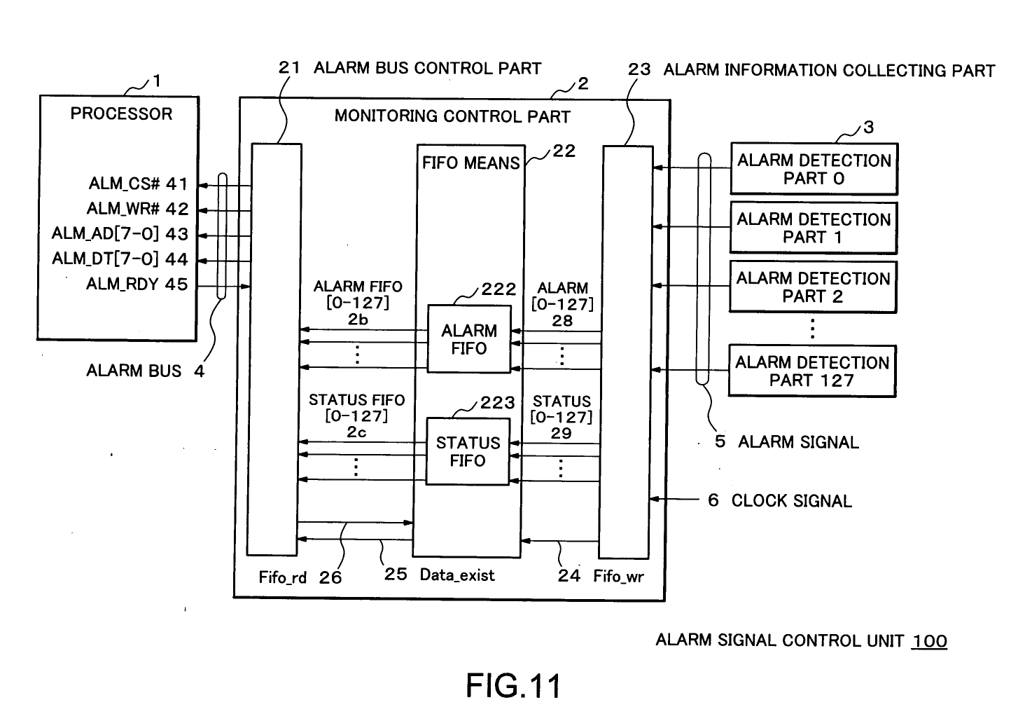

FIG. 11 is an exemplary block diagram showing exemplary alarm signal control apparatus 100 in a second exemplary embodiment of the present invention. In this exemplary embodiment, address signal 27, address FIFO 221, address FIFO signal 2a used in the embodiment shown in FIG. 3 are omitted to simplify the description. Furthermore, although not shown, OR circuit 234 shown in FIG. 5 is also omitted and OR circuit 235 inputs alarm signal 28 including 128 bits.

In this exemplary embodiment, if any one of alarm signals 28 indicates an alarm occurrence, “1” is set in fifo_wr 24 output from OR circuit 23. In such a case, alarm bus control part 21 outputs both alarm FIFO signals [0 to 127] 2b and status FIFO signals [0 to 127] 2c to alarm bus 4 without checking the address FIFOs. Consequently, for example, the apparatus configuration may be simplified, as well as the processing of alarm bus control part 21 is simplified. And because alarm signals are managed on the basis of the FIFO method, for example, alarm bus control part 21 may assure and send an alarm occurred time series to the processor even in such a case.

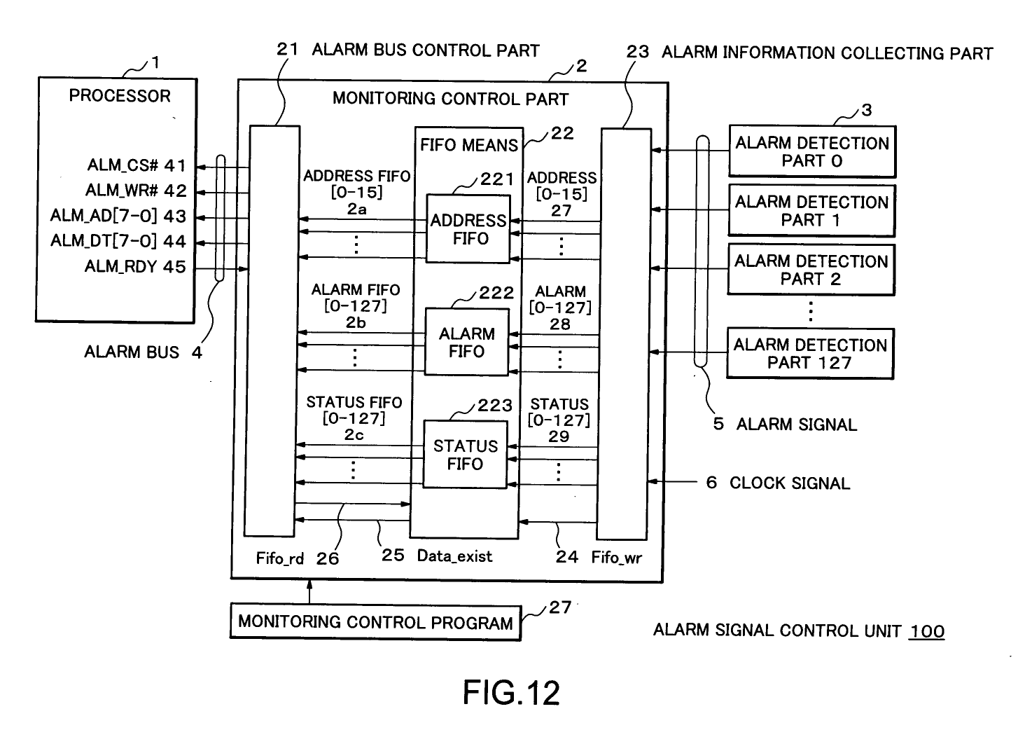

FIG. 12 is an exemplary block diagram showing a configuration of alarm signal control apparatus 100 in a third exemplary embodiment of the present invention. In this third exemplary embodiment, alarm signal control unit 100 is provided with a monitoring control program. This is a difference from alarm signal control unit 100 shown in FIG. 3. In alarm signal control unit 100 shown in FIG. 3, a function of the monitoring control program is realized by hardware. Furthermore, like alarm signal control unit 100 shown in FIG. 12, monitoring control part 2 may read such a monitoring control program to realize the function.

In such a case, monitoring control part 2 comes to have a microprocessor (CPU, MPU, or the like, not shown) to be controlled by programs and operate under the control of monitoring control program 27 stored in a computer program product (e.g., program recording medium). The program recording medium may be any of magnetic disks, magnetic tapes, semiconductor memories, as well as optical disks such as CD-ROMs, DVDs (Digital Versatile Disks), etc. Besides such a program stored in a recording medium, monitoring control part 2 may operate under the control of a program downloaded from a server, etc. through a communication medium.

The alarm signal control method of the present invention may be employed in any of computers provided with a plurality of alarm detection parts, as well as manufacturing of electronic apparatuses. Furthermore, the method may be employed for various electronic apparatuses provided with a processor respectively.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, it is noted that the inventor's intent is to retain all equivalents of the claimed invention even if the claims are amended during prosecution.

This application is based on Japanese Patent Application No. JP 2006-016314 filed on Jan. 30, 2006, and including a specification, claims, drawings and summary. The disclosure of the above Japanese Patent Application is incorporated herein by reference in its entirety.

What is claimed is:

1. A method of controlling a monitoring control apparatus, comprising:
receiving a plurality of alarm signals;
selecting at least one of said plurality of alarm signals; and
sending said at least one alarm signal to a processor.

2. The method according to claim 1, wherein said plurality of alarm signals include a plurality of alarm signal groups, the method further comprising:
sending at least one of said plurality of alarm signal groups to said processor.

3. The method according to claim 2, wherein said alarm signal group sent to said processor includes an alarm signal that includes a status change.

4. The method according to claim 3, further comprising:
receiving a first alarm signal and a second alarm signal that is subsequent to said first alarm signal; and
detecting a status change based on said first and second alarm signals.

5. The method according to claim 1, further comprising:
inputting said alarm signal to a first F/F;
inputting said first alarm signal to a second F/F and an XOR circuit from said first F/F at a next clock timing;
outputting a status signal from said first F/F;
inputting said first alarm signal to said XOR circuit from said second F/F, inputting a second alarm signal to said XOR circuit from said first F/F at a next clock timing;
outputting “0” as an alarm detection signal when said first and second alarm signals are identical, or “1” as an alarm detection signal when said first and second alarm signals are different;
inputting a plurality of alarm detection signals that include said alarm detection signal to a first OR circuit and outputting “1” as an address signal when said plurality of alarm detection signals include “1”;
inputting a plurality of address signals that include said address signal to a second OR circuit; and
outputting an Fifo_wr signal when said plurality of address signals include “1”.

6. The method according to claim 5, further comprising:
inputting said Fifo_wr signal to a FIFO;
inputting address signals [0 to 15] that include said address signal, alarm detection signals [0 to 127] that include said detection signal, and status signals [0 to 127] that include said status signal in one step of said FIFO;
outputting a Data_exist signal to said alarm bus controller, when said address signals [0 to 15] include “1”;
receiving a Fifo_rd signal from said alarm bus controller; and
outputting address FIFO signals [0 to 15] that include said address signals [0 to 15], alarm FIFO signals [0 to 127] that include said alarm detection signals [0 to 127], and status FIFO signals [0 to 127] that include said status signals [0 to 127] to said alarm bus controller.

7. The method according to claim 6, further comprising:
inputting said Data_exist signal from said FIFO;
outputting said Fifo_rd signal to said FIFO;
inputting said address FIFO signals [0 to 15], said alarm FIFO signals [0 to 127], and said status FIFO signals [0 to 127] from said FIFO;
checking said address FIFO signals [0 to 15];
setting the value of said alarm FIFO signals [8(8*n+7)−(8*n)] in an ALM_DT [7 to 0] and writing said value in a processor, if address FIFO signals [n] include “1”; and
setting the value of said status FIFO signal [8(8*n+7)−(8*n)] in said ALM_DT [7 to 0] and writing said value in said processor.

8. A computer program product including a program for causing a monitoring control apparatus to perform the method of claim 1.

9. A monitoring control apparatus, comprising:
an alarm information collector that receives a plurality of alarm signals; and
an alarm bus controller that selects at least one of said plurality of alarm signals, said alarm bus controller sending said at least one alarm signal to a processor.

10. The monitoring control apparatus according to claim 9, wherein:
said plurality of alarm signals include a plurality of alarm signal groups; and
said alarm bus controller sends at least one alarm signal group to said processor.

11. The monitoring control apparatus according to claim 10, wherein said alarm signal group sent to said processor includes an alarm signal that includes a status change.

12. The monitoring control apparatus according to claim 11, wherein said alarm information collector receives a first alarm signal and a second alarm signal that is subsequent to said first alarm signal, said alarm information collector including:
a detector that detects a status change based on said first and second alarm signals.

13. The monitoring control apparatus according to claim 9, further comprising:
a first F/F that receives said alarm signal, said first F/F outputting a status signal and a first alarm signal at a next clock timing;
a second F/F that receives said first alarm signal from said first F/F, said second F/F outputting said first alarm signal at a next clock timing;
an XOR circuit that receives said first alarm signal from said second F/F and a second alarm signal from said first F/F, said XOR circuit outputting “0” as an alarm detection signal when said first and second alarm signals are identical or “1” as an alarm detection signal when said first and second alarm signals are different;
a first OR circuit that receives a plurality of alarm detection signals that include said alarm detection signal, said first OR circuit outputting “1” as an address signal when said plurality of alarm detection signals include “1”; and
a second OR circuit that receives a plurality of address signals that include said address signal, said second OR circuit outputting an Fifo_wr signal when said plurality of address signals include “1”.

14. The monitoring control apparatus according to claim 13, further comprising:
a FIFO that receives said Fifo_wr signal, said FIFO including;
an address FIFO that receives address signals [0 to 15] that includes said address signal in one step of said address FIFO;
an alarm FIFO that receives alarm detection signals [0 to 127] that includes said detection signal in one step of said alarm FIFO; and
an status FIFO that receives status signals [0 to 127] that includes said status signal in one step of said status FIFO, wherein:
said FIFO outputs Data_exist signal to said alarm bus controller when said address signals [0 to 15] include “1”, and said FIFO receives a Fifo_rd signal from said alarm bus controller;
said address FIFO outputs address FIFO signals [0 to 15] that include said address signals [0 to 15] to said alarm bus controller;
said alarm FIFO outputs alarm FIFO signals [0 to 127] that include said alarm detection signals [0 to 127] to said alarm bus controller; and
said status FIFO outputs status FIFO signals [0 to 127] that include said status signals [0 to 127] to said alarm bus controller.

15. The monitoring control apparatus according to claim 14, wherein
said alarm bus controller receives said Data_exist signal from said FIFO;
said alarm bus controller outputs said Fifo_rd signal to said FIFO;
said alarm bus controller receives said address FIFO signals [0 to 15], said alarm, FIFO signals [0 to 127], and said status FIFO signals [0 to 127];
said alarm bus controller checks said address FIFO signals [0 to 15];
said alarm bus controller sets the value of said alarm FIFO signals [8(8*n+7)−(8*n)] in an ALM_DT [7 to 0] and writing said value in a processor, if address FIFO signal [n] include “1”; and
said alarm bus controller sets the value of a region indicated by said status FIFO signals [8(8*n+7)−(8*n)] in said ALM_DT [7 to 0] and writes said value in said processor.

16. An electronic apparatus, comprising:
said alarm signal controller according to claim 9;
an alarm detector that monitors a part in said electronic apparatus and sends said alarm signal to said alarm signal controller; and
a processor that receives an alarm signal from said alarm signal controller.
